(19) United States
(12) Patent Application Publication
(10) Pub. No.: US 2004/0220938 A1
(43) Pub. Date: Nov. 4, 2004

(54) SYSTEM AND METHOD FOR REWARDING PERFORMANCE BASED ON A RATING FROM A THIRD PARTY

(76) Inventor: Ivan Miles Posey, Coto de Caza, CA (US)

Correspondence Address: Ivan Posey, 1 Fair Valley, Coto de Caza, CA, 92679, US

(21) Appl. No.: 10/249,903

(22) Filed: May 16, 2003

Related U.S. Application Data
(63) Continuation of application No. 10/426,759, filed on Apr. 30, 2003.

(51) Int. Cl. G06F 17/00

(52) U.S. Cl. 707/100

(57) ABSTRACT

The disclosed system and method allows third parties such as television viewers and Internet users to rate the performance of reality show contestants who may receive a portion of a performance reward based on the ratings received. Viewers are able to view the reality show. A first subsystem provides or sets aside a possible reward for the contestants. The possible reward may be provided from advertising revenue received for the reality show. A second subsystem receives ratings from the viewers regarding the performance of the some or all of the contestants participating in the reality show. A third subsystem provides a portion of the reward to each contestant that is rated, the size of the portion provided to each contestant depending on the rating from the viewers regarding the performance of the contestant.

### RELATED APPLICATIONS

This application is a continuation in part of Ser. No. 10/426,759, entitled “System And Method For Rewarding Performance,” naming Ivan M. Posey as an inventor and filed Apr. 30, 2003.

### BACKGROUND OF INVENTION

The present invention relates generally to a system and method for rewarding performance in a service or dating referral system. More particularly, and although not exclusively, the present invention relates to a system and method for providing incentive for a referred person or entity to better perform services in a paid for business referral service, and for rewarding social likableness on a date in a dating or matchmaking service, and for rewarding performance based on ratings from third parties in business or reality television shows.

Traditional dating and matchmaking services suffer from the same disadvantages as general referral services, such as employment agencies. While persons patronizing these referral services and agencies may have a natural incentive to perform well, or in the case of dating, impress the other person socially, there is not much more of an incentive to-perform well or behave socially. Even in the case of an employment agency or other business referral service where the person or entity performing business services may receive pay, there may not be an additional incentive to perform better than what is minimally required to perform the business services. In most cases, customers of the agency or referral service often desire a quality of service that is above what is considered minimal, whereas prior art referral services do not encourage the people or agencies financially to provide that extra quality.

In the context of dating services, especially where one customer simply does not like the other customer that they are matched with, there is little added incentive to try to socially impress the other person on a date. This is not to suggest that a person should seek to fallaciously impress a person with whom they are matched on a date if they genuinely do not like that person. However, especially in such a situation, each person should at least be encouraged to socialize with the other person cordially during the date so that neither has a particularly unpleasant experience on the date. On the other hand, even when the matched persons have the potential to like each other, sometimes one or each of them in their nervousness are less affable on a date. However, with added incentive, each person may behave more affably despite his or her nervousness, and each may find out that they do indeed like the other person once there is more social interaction. Current matchmaking systems do not offer such an incentive.

Reality television and entertainment has attained a significant prevalence for television networks as well as the viewing public. Many types of reality shows have been produced, become extremely popular, and have provided an inordinate amount of advertising revenue for television networks. Some of those types of shows include reality dating shows, talent shows, amateur stunt shows and survival shows in which contestants are voted off of the reality show until the last contestant is left to win prizes. Some reality shows merely consist of putting several contestants in the same living quarters for several weeks. Especially with respect to the latter type of show, there is little financial incentive for the contestants to make an extra effort to impress or entertain the viewers of the reality shows once the contestants are selected to participate in the reality show. Even in the case of talent or dating type reality shows where the goal is to impress judges or the dating companion, current shows do not provide a way to provide a reward for impressing or entertaining viewers or other third party observers, nor a way to participate in a portion of the enormous advertising revenue based on such criteria. Further, even in shows where the audience is allowed to have a say in who the last contestant, or winner, of the show should be, there is little financial incentive for the contestant impress the audience more than is needed to win the competition against the other contestants.

### SUMMARY OF INVENTION

The above shortcomings in dating services, general referral services, and reality shows are resolved by the present invention. In one context, a matchmaking system providing a method for rewarding likableness on a date is disclosed. A first subsystem is for tracking compensation accepted from a first customer of the matchmaking service system for the system's matching or referring of one or more second customers of the matchmaking service system for a date. A second subsystem provides for the receiving of a rating from the first customer regarding the likableness of the second customer. A third subsystem is for providing a portion of the compensation from the first customer to the second customer, the size of the portion provided to the second customer depending on the rating received from the first customer.

A system for providing incentives or rewards for high ratings from customers in the performance of business services is also disclosed. In that context, the first subsystem may be used for tracking compensation accepted from a customer. The compensation is accepted by the first subsystem for referring a person or entity to perform services. The second subsystem may be for receiving a rating from the customer regarding the performance of services. The third subsystem may be for providing a portion of the compensation to the person or entity, the size of the portion depending on the rating

In another context, instead of the participants providing the ratings that are used to determine the performance rewards, a third party who is not a participant or customer of the system may provide the ratings. Such a system that allows a third party to provide a rating also has tremendous value in the area of reality show television or entertainment. The system may be used to allow such third parties as television viewers and Internet users to rate the performance of the reality show contestants who may receive a portion of a performance reward based on the ratings received.

### BRIEF DESCRIPTION OF DRAWINGS

These and other features and advantages of the invention will now be described with reference to the drawings of certain preferred embodiments, which are intended to illustrate and not to limit the invention, and in which:

FIG. 1 is a high-level architectural drawing illustrating the primary components of a system that operates in accordance with the present invention;

FIG. 2 is a performance tracking database table used by the system of FIG. 1;

FIG. 3 is a flow diagram of a generic method that can be used to operate the matchmaking system of FIG. 1 or other generic or business referral systems that can operate on the system of FIG. 1; and

FIG. 4 is a flow diagram of a method that can be used by a reality television show using the system of FIG. 1.

### DETAILED DESCRIPTION

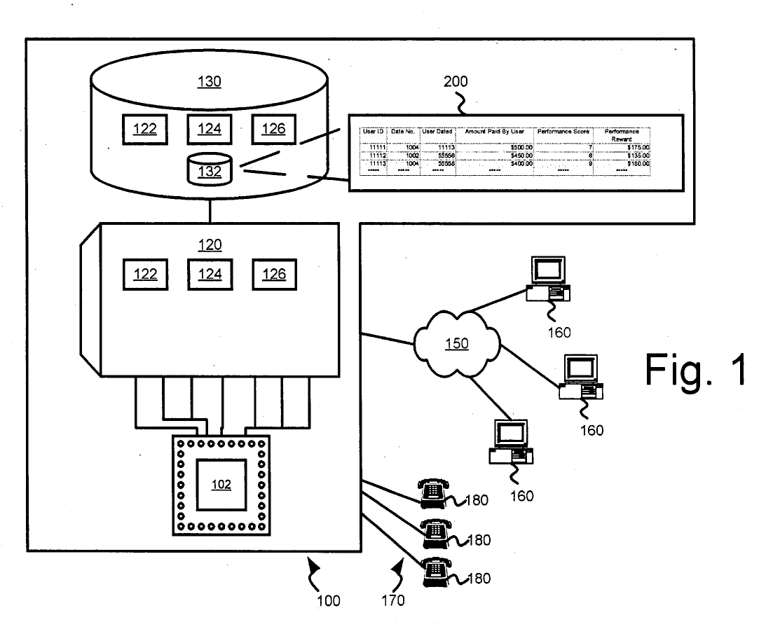

With reference to FIG. 1, a high-level architectural drawing illustrating the primary components of an embodiment of a matchmaking system 100 according to the present invention is shown. The matchmaking system 100 performs a method for rewarding likableness on a date. The matchmaking system 100 may comprise a generic data processing system such as a personal computer comprising a central processing unit 102. However, system 100 may comprise a variety of different computing platforms such as mid-range or large mainframe computing systems. The processor 102 may use reduced instruction set or complex instruction set technology.

In the embodiment of FIG. 1, the matchmaking system 100 includes several subsystems 122-126, which are each comprised of executable software instructions for executing using the central processing unit 102. After programming or installation on the matchmaking system 100, the subsystems 122-126 are stored on a storage device 130 which may comprise, for example, a mass storage device or solid-state non-volatile storage device such as hard disk or safe-RAM. As each subsystem is needed for operation of the matchmaking system 100, the appropriate subsystems 122-126 may be loaded into a system memory 120, which may comprise, for example, higher-speed volatile storage 120 such as a system random access memory (RAM) or the like. Those skilled in the art would recognize that the system 100 shown in FIG. 1 may comprise a personal computer or server computer running the WINDOWS NT or 2000 operating system by the Microsoft Corporation of Redmond Wash., storing and executing the subsystems 122-126.

Also included may be a comprehensive matchmaking database 132 for providing known matchmaking capabilities for users of the matchmaking system 100. One example of such a database 132 is shown and described in U.S. Pat. No. 6,061,681. Described in that patent is a database for implementing a system for matching people with each other. The database stores user information to match a particular user with at least one other user of the system. Those skilled in the art would recognize that other matchmaking database systems may implemented for database 132, such as that provided for YAHOO PERSONALS by Yahoo!, Inc. of Sunnyvale, Calif. With each of these and other databases that may comprise database 132 uses, the database may be to updated and read via one or more user computers 160 connected to a network 150, such as the Internet, to access server pages produced by the system 100. In some embodiments, the database 132 may be updated and read by users via one or more telephones 180 connected via the telephone network 170, the matchmaking system 100 further comprising a voice response system for receiving voice or keypad input as is commonly used, for example, in many customer service and airline flight reservation and tracking systems.

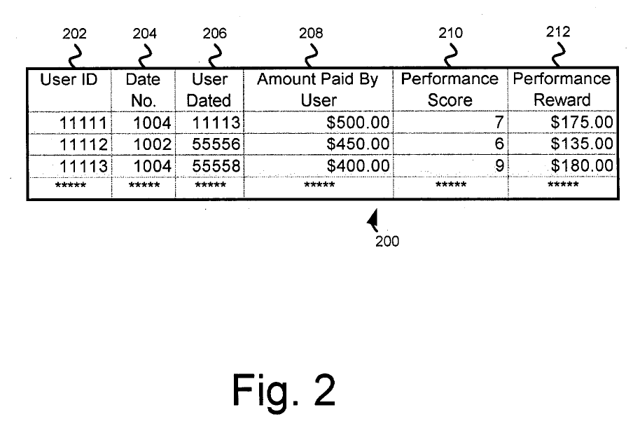

Also included in the database 132 are one or more performance tables 200 for keeping track of performance reward data for each date as explained in more detail with reference to FIG. 2 below.

The first subsystem 122 is for tracking compensation accepted from a first customer of the matchmaking service system 100 for the system's matching or referring of one or more second customers of the matchmaking service system 100 for a date. The compensation paid by the first customer is stored in the performance table 200.

The second subsystem 124 provides for the receiving of a rating from the first customer regarding the likableness of the second customer. Subsystem 124 may utilize, for example, Internet page access using the user computers 160 or telephone voice-response access using the telephones 180 as referred to above.

The third subsystem 126 is for providing a portion of the compensation from the first customer to the second customer, the size of the portion provided to the second customer depending on the rating received from the first customer. The rating, for example, may be based on a scale of 0-10, with 10 representing that the first customer thought that the second customer was an excellent social or dating companion, and for example, the first customer would like to have another date with the second customer if the second customer would like to do so, with 0 representing that the first customer thought that the second customer was the worst possible social or dating companion, and, for example, the first customer would not like to have another date with the second customer. In other words, the rating received from the first customer may gage the likableness of the second customer as demonstrated by the second customer on the date.

With reference to FIG. 2, an example performance table 200 that may be used by the embodiment of the system 100 of in FIG. 1 is shown. In the example table 200 of FIG. 2, the records are organized by each date participated in by two customers. Each customer of the matchmaking system 100 may be tracked using a unique customer identification number (customer ID) assigned to each customer of the matchmaking system 100. For each date, a user ID field 202 of table 200 stores the first customer's unique customer ID who participated in the date for each particular record. A date number field 204 stores a unique date number used by the matchmaking system 100 for tracking each date participated in by two customers. A user dated field 206 stores the customer ID of the second customer who participated in the date.

An amount paid by user field 208 stores the compensation accepted from a first customer identified in field 202 for the system's matching or referring of the second customer identified in field 206 for the date identified in field 204. In many dating services, customers pay a certain amount for a guaranteed certain number of referrals. In other dating services, customers pay for each actual referral. The first subsystem 122 handles either such case, or any other compensation scheme which may be used for the matchmaking system 100. For example, in FIG. 2, the customer identified by customer ID 11111 may have paid $1,500 for a total of 3 guaranteed referrals for dates. The first subsystem calculates that the customer paid $500 for each referral, and thus, that amount is entered into field 208 as the amount of compensation accepted by the system 100 for the particular date represented by date number 1004 shown in field 204. Further, some customers may have paid less to join the matchmaking service 100, or have taken advantage of special discounts offered to pay for further referrals, which explains the varying amounts of compensation shown between the records in field 208.

After the date, when the second subsystem receives a rating from the first customer, the rating is entered into a performance score field 210. Once the rating is entered into field 210, the third subsystem 126 may then automatically calculate the portion of the compensation in field 208 to be provided to the second customer based on the rating and enter that portion into a performance reward field 212. Standard security and password protection procedures may be used by the third subsystem 126 to make sure that the first customer is truly the customer providing the rating, such as a combination of the customer ID and a unique password selected or provided to the first customer.

There are various ways to calculate the portion of the compensation that is the performance reward based on the rating entered. For example, the calculation used in FIG. 2 takes half of the compensation entered in field 208, and multiplies the result by 0.1 times the rating in the performance score field 210. This method provides 5 percent of the compensation provided by the first customer to the second customer for each point or rating received from the first customer. This method of calculation provides for one form of a generous but reasonable percentage of the compensation paid by the first customer to the second customer to provide an incentive to the second customer to be more social, interactive or pleasant on the date. In other words, the portion of the compensation provides a dating performance reward to the second customer. However, other formulas or methods of calculation may be used other than the straight-line method illustrated, including graduated or curved scales.

The performance incentive may work both ways. For example, in the first record with customer ID 11111 in the user ID field 202 and date number 1004 in the date number field 204, the second customer being rated by the first customer is identified by customer ID 11113 as shown in the user dated field 206. As shown in the third record with customer ID 11113 in the user ID field 202 and the same date number 1004 in the date number field 204, the second customer rates the first customer for the same date. At least in some cases in the illustrated embodiment, the first subsystem 122 is further for tracking compensation accepted from the second customer; the second subsystem 124 is further for receiving a rating from the second customer regarding the likableness of the first customer; and the third subsystem 126 is further for providing a portion of the compensation from the second customer to the first customer, the size of the portion provided to the first customer depending on the rating from the second customer.

It should be noted that in some embodiments of the matchmaking system 100, it is not necessary that all or any of the steps be performed using a processor or computer programs. The first, second and third subsystems 122-126 of the matchmaking system 100 may each individually be of a type selected from the group consisting of: a ledger, a computerized accounting system, a database system, an on-line server connected to a network, an HTML system, an internet matchmaking system, a computerized spreadsheet and software based matchmaking system. For example, in a manual system embodiment, the table 200 of FIG. 2 may comprise paper-based ledger wherein the data is manually entered by a matchmaking agency. The ratings are received by the matchmaking agency in person or over the telephone. Checks are manually cut to send to the deserving customers after their performance rewards are calculated by hand or using a calculator. In the other extreme, in a highly computerized embodiment of the matchmaking system 100, after the performance award is calculated, the system 100 may send a signal to a bank where an account is kept for the system 100 to automatically print a check to send to the second customer in the amount of the performance reward. Various levels of human verification may be added before such a transaction is ordered, but those skilled in the art would recognize that such electronic transactions are common, and may also include electronic transfers of funds if the second customer provides their bank account information. In another embodiment, computerized spreadsheet system such as EXCEL by the Microsoft Corp. of Redmond, Wash. is used for table 200.

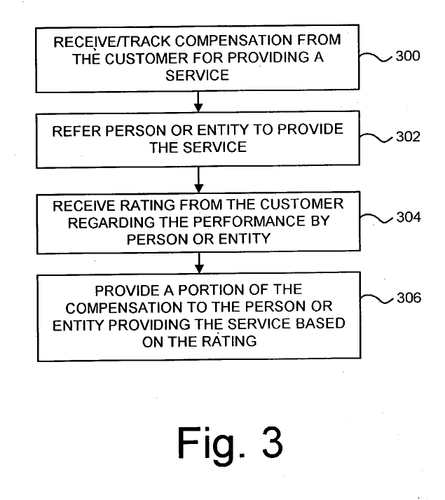

While the above system 100 of FIG. 1 is described to implement a dating or matchmaking service, the system 100 may be used to provide a generic system for rewarding performance in other contexts. For example, the system 100 may provide incentives or rewards for high ratings from customers in the performance of business services. In that regard, reference is made to FIG. 3, which illustrates a flow chart regarding a generic method that can be performed by the system 100 of FIG. 1 For example, the first subsystem 122 may be used for tracking compensation accepted from a customer, step 300. The compensation is accepted by the subsystem 122 for referring a person or entity to perform services, which may comprise, for example, business services, step 302. The second subsystem 124 may be for receiving a rating from the customer regarding the performance of services, step 304. The third subsystem 126 may be for providing a portion of the compensation to the person or entity, the size of the portion depending on the rating, step 306.

Employment agencies may use this method. In that context, the customer is an employer, the person or entity is an employee, and the services are the services performed by the employee for the employer. The employment agency referring the employee to the employer provides the performance reward to the employee based on the rating received from the employer.

A general contractor may use this method. The services may comprise subcontracted services performed by a subcontractor for the customer. The general contractor similarly provides a performance reward to the subcontractor based on a rating received from the customer.

In another embodiment, instead of the participants providing the ratings that are used to determine the performance rewards, a third party who is not a participant or customer of the system may provide the ratings. For example, in the case where the general contractor is to reward a subcontractor based on the rating, it may be advantageous to have a third party inspector inspect the work performed by the subcontractor. In a construction contract, for instance, this may involve having a licensed construction inspector review the construction work performed by the subcontractor, and then provide a rating to the general contractor regarding the quality of the work. Such a system discourages any bias that the customer of the general contractor may have in evaluating the work, and providing the rating.

Such a system that allows a third party to provide a rating also has tremendous value in the area of reality show television or entertainment. The system of FIG. 1 and 2 may be used to allow such third parties as television viewers and Internet users to rate the performance of the reality show contestants who may receive a portion of a performance reward based on the ratings received.

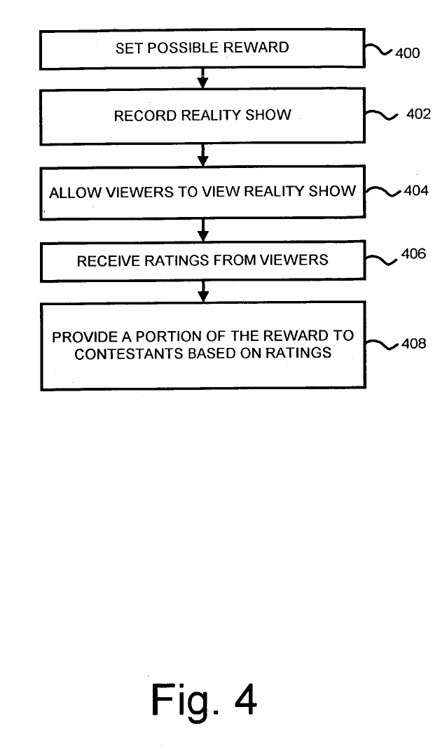

With reference to FIG. 4, a flow diagram illustrating the steps that may be performed using the system of FIG. 1 to reward performance of reality show contestants is shown. The context of the method is in a reality show wherein one or more viewers are able to view at least portions of the reality show having contestants. The first subsystem (122 in FIG. 1) provides or sets aside a possible reward for contestants, step 400. In one embodiment, the possible reward is provided from advertising revenue received for the reality show, which may be very significant, which would prompt the reality show contestants to perform at their best.

The reality show is filmed or otherwise recorded, step 402. As those in the entertainment industry would recognize, recording may involve 24 hour surveillance of each contestant in the reality show over a period of time, with editing to put together separate portions for broadcast, or recording may involve recording some portions of the reality show which are then edited together before broadcast. Once editing of the reality show is completed, viewers may then be allowed to view the edited version of the reality show, step 404. Broadcast of the show may be over television networks, or as simple as providing key scenes and descriptions on an internet web site. Alternatively, the broadcast may occur in special screens or in movie theaters, or on pay-per-view cable and satellite television.

Once the viewers are given the opportunity to view the reality show, in the same manner discussed above, the second subsystem (124 in FIG. 1) receives ratings from the viewers regarding the performance of the some or all of the contestants participating in the reality show, step 406. The second subsystem may receive the ratings over the Internet (network 150 in FIG. 1), using the telephone network (170 in FIG. 1), or even using rating cards from magazine inserts that are filled and mailed in by viewers. In the case where screenings are in movie theaters, rating buttons or handsets may be provided to the viewers to receive their ratings, which are then recorded and forwarded to the system 100. For cable and satellite viewers, interactive cable and satellite receivers may receive input from viewers' remote control handsets to receive ratings.

The third subsystem (126 in FIG. 1) provides a portion of the reward to each contestant that is rated, the size of the portion provided to each contestant depending on the rating from the viewers regarding the performance of the contestant, step 408. The ratings may be stored in the database (132 in FIG. 1) by either storing each rating received, or keeping a weighted average of all ratings as they are received.

Similarly to the other embodiments described herein, each contestant in the reality show is matched in the database 132 by a customer or contestant ID, which is also used to organize table 200 (FIG. 2). Depending on whether the reality show is a dating show, fields 204 and 206 may not be needed. However, depending on the type of show, other fields may be needed, such as fields to keep track of running rating averages over the a mutli-episode series for each contestant or teams of contestants. Field 208 may be needed if the game show format has different performance rewards available for each contestant, or for different events in which contestants may compete. Field 210 may be used to store the ultimate performance score for each contestant for each record, and the ultimate performance reward may be calculated and stored in field 212 for each record. Each record in table 200 may represent, for example, a different event for each contestant, or a different episode of the reality show for each contestant.

In some embodiments, the contestants may divide up a portion of the set aside performance reward based on the ratings that each of the contestants receives with respect to one another. For example, a maximum number of 100 points may be available to the contestants, each point representing an equal portion of a reward set aside. Ratings received from the viewers for each contestant may be added to each contestant's total score. Once ratings are received, the ratings received for each contestant are added together, and the percentage of the total points received by each contestant determines the number of points the contestant receives, and therefore the percentage of the performance reward received by the contestant.

Although the invention has been described in terms specific types of elements, as well as with reference to certain methodological acts, it is to be understood that the invention defined in the appended claims is not necessarily limited to the specific structures or acts described. The specific structural features and acts therefore are disclosed as exemplary embodiments implementing the claimed invention.

Further, the embodiments described above are provided by way of illustration only and should not be construed to limit the invention. Those skilled in the art will readily recognize various modifications and changes that may be made to the present invention without following the exemplary embodiments and applications illustrated and described herein, and without departing from the scope of the present invention, which is set forth in the following claims.

1. A method for rewarding performance, comprising: accepting compensation from a customer for referring a person or entity to perform services; a third party evaluating performance of the services; receiving a rating from the third party regarding the performance of services; and providing a portion of the compensation to the person or entity, the size of the portion depending on the rating.

2. The method of claim 1, wherein the services comprise duties performed by an employee for the customer, the customer providing the compensation to an employment agency, the employment agency providing the portion to the employee.

3. The method of claim 1, wherein the services comprise subcontracted services performed by subcontractor for the customer, the customer providing the compensation to a general contractor, which provides the portion to the subcontractor.

4. In a matchmaking show wherein one or more viewers are able to view at least portions of a date with a first contestant and a second contestant, a method for rewarding performance on the date, comprising: providing a possible reward for the first contestant; recording one or more portions of the date; allowing the viewers to view the one or more portions of the date; receiving a rating from one or more of the viewers regarding the performance of the first contestant; and providing a portion of the reward to the first contestant, the size of the portion provided to the first contestant depending on the rating from the one or more viewers regarding the performance of the first contestant.

5. The method of claim 4, wherein the possible reward is provided from advertising revenue received for the matchmaking show.

6. The method of claim 4, further comprising receiving a rating from one or more viewers regarding the performance of the second contestant and providing a portion of the reward to the second contestant, the size of the portion provided to the second contestant depending on the rating from the one or more viewers regarding the second contestant.

7. In a reality show wherein one or more viewers are able to view at least portions of the reality show having at least a first contestant, a method for rewarding performance on the reality show, comprising: providing a possible reward for the first contestant; recording one or more portions of the reality show; allowing the viewers to view the one or more portions of the reality show;receiving a rating from one or more of the viewers regarding the performance of the first contestant; and providing a portion of the reward to the first contestant, the size of the portion provided to the first contestant depending on the rating from the one or more viewers regarding the performance of the first contestant.

8. The method of claim 7, wherein the possible reward is provided from advertising revenue received for the reality show.

9. The method of claim 7, wherein the reality show has at least a second contestant, further comprising receiving a rating from one or more viewers regarding the performance of the second contestant and providing a portion of the reward to the second contestant, the size of the portion provided to the second contestant depending on the rating from the one or more viewers regarding the second contestant.
